(19) United States
(12) Patent Application Publication
(10) Pub. No.: US 2012/0275267 A1
(43) Pub. Date: Nov. 1, 2012

(54) Seismic Data Processing

(76) Inventors: Ramesh Neelamani, Houston, TX (US); Partha S. Routh, Katy, TX (US); Jerome R. Krebs, Houston, TX (US); Anatoly Baumstein, Houston, TX (US); Thomas A. Dickens, Houston, TX (US)

(21) Appl. No.: 13/430,380

(22) Filed: Mar. 26, 2012

Related U.S. Application Data
(60) Provisional application No. 61/479,199, filed on Apr. 26, 2011.

(51) Int. Cl. G01V 1/28

(52) U.S. Cl. 367/38

(57) ABSTRACT

Provided is a method for processing seismic data. One exemplary embodiment includes the steps of obtaining a plurality of initial subsurface images; decomposing each of the initial subsurface images into components; identifying a set of components comprising one of (i) components having at least one substantially similar characteristic across the plurality of initial subsurface images, and (ii) components having substantially dissimilar characteristics across the plurality of initial subsurface images; and generating an enhanced subsurface image using the identified set of components. Each of the initial subsurface images is generated using a unique random set of encoding functions.

### CROSS-REFERENCE TO RELATED APPLICATION

This application claims the benefit of U.S. Provisional Patent Application 61/479,199, filed Apr. 26, 2011, entitled SEISMIC DATA PROCESSING, the entirety of which is incorporated by reference herein.

### FIELD OF THE INVENTION

The invention relates generally to the field of geophysical prospecting, and more particularly to seismic data processing. Specifically, the invention is a method for identifying and/or reducing signal noise introduced by various conventional inversion techniques.

### BACKGROUND OF THE INVENTION

Geophysical inversion attempts to find a model of subsurface properties that optimally explains observed data and satisfies geological and geophysical constraints. There are a large number of well known methods of geophysical inversion. These well known methods fall into one of two categories, iterative inversion and non-iterative inversion. The following are definitions of what is commonly meant by each of the two categories:
a. Non-iterative inversion—inversion that is accomplished by assuming some simple background model and updating the model based on the input data. This method does not use the updated model as input to another step of inversion. For the case of seismic data these methods are commonly referred to as imaging, migration, diffraction tomography or Born inversion.
b. Iterative inversion—inversion involving repetitious improvement of the subsurface properties model such that a model is found that satisfactorily explains the observed data. If the inversion converges, then the final model will better explain the observed data and will more closely approximate the actual subsurface properties. Iterative inversion usually produces a more accurate model than non-iterative inversion, but is much more expensive to compute.

In general, inversion is beneficial in correcting observed seismic data so that reflections are plotted at a true representation of their subsurface locations (Stolt, 1978; Claerbout, 1985). The need to correct (i.e., invert) observed seismic data arises, for example, because reflections from dipping interfaces are observed, and therefore recorded, at surface positions that are not directly above the subsurface locations where the reflections actually occur. Also, isolated point-like discontinuities in the subsurface (i.e., point scatterers) generate seismic events (e.g., diffractions) recorded over a large range of receivers. Such diffractions can make the proper interpretation of seismic data confusing. Furthermore, seismic velocity variations can also cause a distorted view of the subsurface geology (Yilmaz, 1987). It is only after inversion that the structures and geometric configurations observed in seismic recordings can be thought of as an accurate depiction of the geologic layers that gave rise to the seismic reflections.

Because of the increased complexity of iterative inversion, it is generally desirable to use a non-iterative form of inversion (i.e., imaging, migration, etc.) when possible. However, as industry explores more complex geographic areas, traditional imaging and interpretation methods fail to provide subsurface images having the quality (e.g., accuracy) desired in making decisions on exploration and production. For example, wave-equation migration algorithms are based upon the one-way wave-equation approach. The one-way wave equation assumes that waves propagate in only one primary direction, either down into the subsurface or up from the subsurface. Because of the one-directional nature of propagation, imaging steeply dipping reflectors is difficult.

Advanced imaging tools that use full physics of wave-propagation, such as reverse time migration (i.e., RTM), generally provide better images of the subsurface. Such approaches use solutions of the two-way wave equation. Migration techniques that use the two-way wave equation generally provide a more accurate result because waves propagating in all directions are handled equally well, and wave amplitudes are properly modeled since no approximations are used in the algorithm. However, there is a cost associated with conventional two-way wave equation techniques. Specifically, the full physics of propagating waves in a complex geological setting where the medium velocity is complicated is very computationally intensive. The computational demand is further accentuated when there are many (e.g., thousands) shot records to be migrated in a three-dimensional (3D) setting and/or when high frequency data is obtained in an effort to increase the resolution of the subsurface images. It is desirable, therefore, to have a system and/or method for increasing the computational efficiency (i.e., reducing the computational cost) of two-way wave equations based techniques, such as RTM.

### SUMMARY OF THE INVENTION

The present disclosure relates generally to the field of geophysical prospecting, and more particularly to seismic data processing. One exemplary embodiment includes the steps of obtaining a plurality of initial subsurface images; decomposing each of the initial subsurface images into components; identifying a set of components comprising one of (i) components having at least one substantially similar characteristic across the plurality of initial subsurface images, and (ii) components having substantially dissimilar characteristics across the plurality of initial subsurface images; and generating an enhanced subsurface image using the identified set of components. Each of the initial subsurface images is generated using a unique random set of encoding functions.

Another exemplary embodiment includes the steps of obtaining a plurality of SS-RTM subsurface images; decomposing each of the plurality of SS-RTM subsurface images into curvelet coefficients; averaging the curvelet coefficients to generate a preliminary signal curvelet coefficient estimate; computing a variance of a subset of the curvelet coefficients to determine a noise level in the preliminary signal curvelet coefficient estimate; attenuating noise in the curvelet coefficients using the determined noise level and the preliminary signal curvelet coefficient estimate to generate attenuated curvelet coefficients; and performing an inverse curvelet transform on the attenuated curvelet coefficients to generate an enhanced SS-RTM image. Each of the SS-RTM subsurface images is generated using a unique random unit-magnitude set of encoding functions.

Yet another exemplary embodiment includes computing a gradient of a cost function associated with seismic data by generating a plurality of gradients of objective functions computed using unique sets of random reciprocal encoding functions; decomposing each of the gradients into components; identifying a set of components having at least one substantially similar characteristic across the plurality of gradients; and generating an enhanced gradient using the identified set of components.

### BRIEF DESCRIPTION OF THE DRAWINGS

The patent or application file contains at least one drawing executed in color. Copies of this patent or patent application publication with color drawings will be provided by the Office upon request and payment of the necessary fee.

The present invention will hereinafter be described in conjunction with the following figures, wherein like numerals denote like elements, and

FIG. 1 is a flow diagram of a method for iteratively performing SS-RTM in accordance with an embodiment of the present invention;

FIG. 2 is a flow diagram of a method for generating an enhanced image in accordance with an embodiment of the present invention;

FIGS. 3A-3D are images corresponding to an exemplary simulated application of one or more embodiments of the present invention; and

FIGS. 4A-4B illustrate the distribution in different domains of the noise corresponding to the exemplary simulated application of FIG. 3.

### DETAILED DESCRIPTION

### Definitions

Various terms as used herein are defined below. To the extent a term used in a claim is not defined below, it should be given the definition persons in the pertinent art have given that term.

As used herein, the “a” or “an” entity refers to one or more of that entity. As such, the terms “a” (or “an”), “one or more”, and “at least one” can be used interchangeably herein unless a limit is specifically stated.

As used herein, the terms “comprising,” “comprises,” “comprised,” and “comprise” are open-ended transition terms used to transition from a subject recited before the term to one or more elements recited after the term, where the element or elements listed after the transition term are not necessarily the only elements that make up of the subject.

As used herein, the terms “containing,” “contains,” and “contain” have the same open-ended meaning as “comprising,” “comprises,” and “comprise.”

As used herein, the term “exemplary” means “serving as an example, instance, or illustration.” Any embodiment described herein as “exemplary” is not necessarily to be construed as preferred or advantageous over other embodiments.

As used herein, the terms “having,” “has,” and “have” have the same open-ended meaning as “comprising,” “comprises,” and “comprise.”

As used herein, the terms “including,” “includes,” and “include” have the same open-ended meaning as “comprising,” “comprises,” and “comprise.”

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

### DESCRIPTION

For illustrative purposes, the present invention is described below in connection with reverse time migration and, more specifically, simultaneous source reverse time migration (i.e., SS-RTM). However, it will be apparent to one skilled in the art having the benefit of this disclosure that the present technique may be used in connection with any two-way wave inversion technique.

The significant computational cost of RTM imaging is driven by the wavefield extrapolation procedure. This procedure comprises accurate forward propagation of the source wavefield as well as backward propagation of the recorded receiver wavefield. These propagated wavefields are then combined by an imaging condition (e.g., cross-correlation) to produce a corresponding subsurface image (Whitmore, 1983; Baysal et al., 1983). In traditional depth-imaging of seismic data, individual shot gathers (i.e., source and receiver wavefield pairs corresponding to source and receiver hardware pairs) are imaged separately; that is, for each shot, the source and receiver wavefields are extrapolated and then combined to produce the subsurface image. The complete RTM image is constructed by combining the subsurface images generated from each shot. For such an approach, the cost of imaging is directly proportional the number of shots. Thus the cost of RTM increases significantly as the number of shots increases.

Simultaneous source migration (Romero et al., 2000) is one technique that may be used to reduce the computational cost of RTM. In simultaneous source imaging, several shots are encoded using a random encoding function to form a super-shot, and this super-shot is then migrated. The computational cost of migrating a super-shot is similar to the cost of migrating a single shot. Thus the use of simultaneous source migration may significantly reduce the cost of RTM. Unfortunately, the use of simultaneous source migration generally introduces undesirable noise into the resulting subsurface image. Most notably, the image suffers from interference between the different sources. Consequently, the resulting SS-RTM image suffers from low signal to noise ratio.

The basic mathematical framework of simultaneous source migration can be described as explained below. Let S(i) denote each source wavefield, of which there is generally many, and R(i,j) denote the receiver wavefield activated by a given S(i). The interference arises because the cross-correlation between the forward propagated S(i) and back-propagated R(k,j), for k≠i, is not zero. More specifically:

Effective SuperShot=Σᵢa(i)S(i) [EQ 1]

Effective SuperShot receiver measurement at j-th receiver=Σᵢa(i)R(i,j) [EQ2]

In conventional SS-RTM, the Effective SuperShot source would be forward propagated, and the effective SuperShot receiver measurement would be back-propagated. The results of the forward and back propagation would then be crosscorrelated (denoted by [symbol] ). Let F denote forward propagation and B denote back propagation operators.

$$\begin{matrix}Image = F [ {\sum }_{i} a ( i ) S ( i ) ] ⊗ B [ \sum a ( k ) R ( k , j ) ] \\ = ( {\sum }_{i} {\vert a ( i ) \vert}^{2} F [ S ( i ) ] ⊗ B [ R ( i , j ) ] ) + \\ ( {\sum }_{i , k} a ( i ) {a}^{*} ( k ) F [ S ( i ) ] ⊗ B [ R ( k , j ) ] )\end{matrix} \qquad [ EQ3 ]$$

where * denotes complex conjugation.

Note that:

Signal (1st term in Image)=F[S(i)] [symbol] B[R(i,j)] and [EQ4]

Interference Noise (2nd term in Image)=F[S(i)] [symbol] B[R(k,j)], with k≠i [EQ5]

It may be beneficial, therefore, to distinguish between, and then subsequently separate, the signal and noise components from the SS-RTM image. It may be noted that instead of measured receiver wavefields and source wavefields; one can use preconditioned/pre-processed receiver and source wavefields to construct the SS-RTM image.

One conventional technique that attempts to reduce the noise component is to use random source encoding (Romero et al., 2000; Perrone and Sava, 2009, 2010). Typically several runs with different encodings are carried out and the images from those runs are then stacked; see Ober et al, U.S. Pat. No. 6,021,094, and Romero et al, 2000. Such a method may produce an image with less artifacts. However, such an approach relies solely on averaging to perform noise attenuation and does not fully leverage the diversity of information in the available encoded SS-RTM images.

Another conventional technique that may reduce cross-talk artifacts is to formulate the Simultaneous Source imaging problem as a least-squares migration problem (Verschuur and Berkhout, 2009; Tang and Biondi, 2009; Dai and Schuster, 2009). Perrone and Sava (2009; 2010) investigated different encoding schemes as well as mixed encoding schemes such as a combination of linear and random encoding to reduce cross-talk artifacts. Godwin and Sava (2010) use singular value decomposition to determine an encoding scheme that attempts to balance computational cost savings with the number of cross-talk artifacts. The Godwin-Sava method inherently assumes that the images generated using each encoding is stacked. As such the Godwin-Sava method does not permit the estimation of the signal components that are not imaged in the final result without conducting additional SS-RTM runs and stacking the resulting images.

It may be appreciated from the above discussion, then, that a need exists for a better system and/or method for reducing noise component (i.e., cross-talk artifacts). The present invention provides such a system and/or method. In contrast to conventional techniques which generally use the same encoding for each source and receiver pair (see EQ1 and EQ2), the present invention may, in at least one embodiment, optionally use a first set of encodings for the sources and a second set of encodings for the receivers. That is:

Effective SuperShot=Σᵢa(i)S(i), and [EQ6]

Effective SuperShot receiver measurement at j-th receiver=Σᵢb(i)R(i,j) [EQ7]

Consequently, the effective SS-RTM image may be given by:

$$\begin{matrix}Image = F [ {\sum }_{i} a ( i ) S ( i ) ] ⊗ B [ \sum b ( k ) R ( k , j ) ] \\ = ( {\sum }_{i} a ( i ) {b}^{*} ( i ) F [ S ( i ) ] ⊗ B [ R ( i , j ) ] ) + \\ ( {\sum }_{i , k} a ( i ) {b}^{*} ( k ) F [ S ( i ) ] ⊗ B [ R ( k , j ) ] )\end{matrix} \qquad [ EQ8 ]$$

In at least one other embodiment, however, the present invention may use the same and/or equivalent encoding for each source and receiver pair.

In general, the present invention comprises the following steps to improve signal and interference noise separation in SS-RTM images. First, SS-RTM is performed a plurality of times to generate a plurality of subsurface images. Different “reciprocal” sets of source and receiver random encoding functions are used during each application of SS-RTM to the set of shot gathers. It may be understood that a pair of random encoding functions, such as aₙ(i) and bₙ(i), are “reciprocal” when aₙ(i)=1/bₙ*(i) or aₙ(i)=bₙ(i)=0, where n denotes the SS-RTM run index. Second, the resulting signal and noise characteristics are used along with the plurality of resulting SS-RTM images to generate an enhanced image with reduced interference noise. With regard to the second step, and as previously discussed, one conventional strategy to obtain an enhanced image is to average (i.e., stack) a plurality of generated subsurface images; see Ober et al, U.S. Pat. No. 6,021,094, and Romero et al, 2000. During stacking, the signal component adds constructively (i.e., stacks in) and the noise component gets attenuated (i.e., stacks out). The stacked image can be mathematically expressed as

$$Stack = \frac{{\sum }_{n = 1}^{N} {Image}_{n}}{N} = Signal + \frac{{\sum }_{n = 1}^{N} {Noise}_{n}}{N} \qquad [ EQ9 ]$$

The signal-to-noise-ratio (i.e., SNR) of the signal and noise events may be predicted as a function of the number of runs. The noise energy would be controlled by the average of a string of random phase (such as ±1) numbers. It is possible to show that the all interference noise terms would cancel out after stacking only when Nₛ SS-RTM runs are conducted, with Nₛ denoting the number of shots, and the encodings chosen to be orthogonal to each other. Note that if Nₛ SS-RTM runs are conducted, then no efficiency is gained. When substantially fewer than Nₛ SS-RTM runs (i.e., N<<Nₛ) are conducted, then simple stacking of the SS-RTM images does not adequately attenuate the interference noise. It is desirable, therefore, to have a system and/or method for generating an enhanced image that does not exhibit the deficiencies of the stacking method.

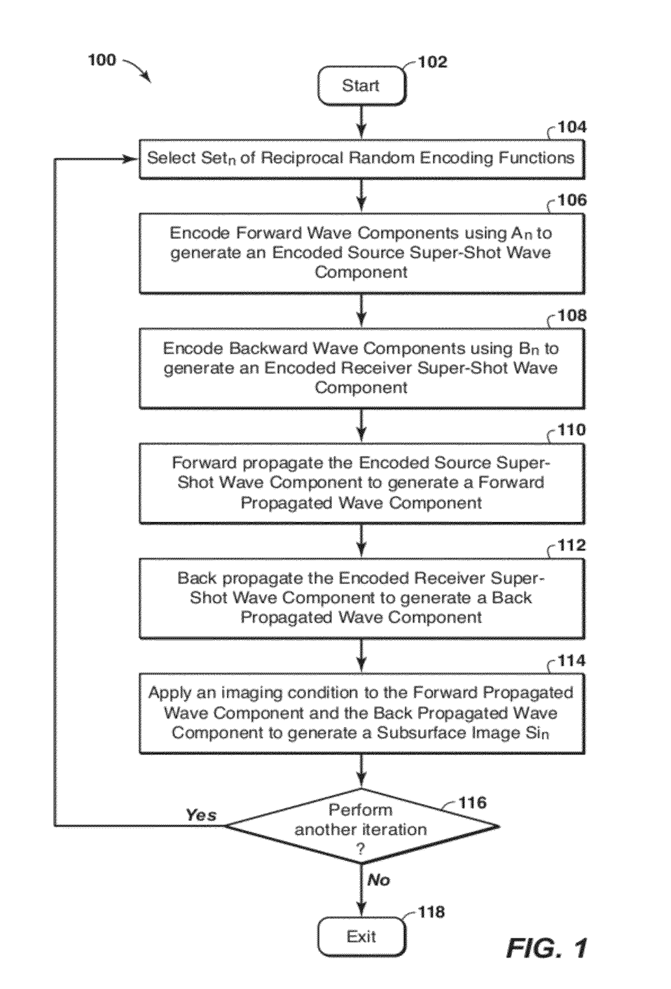

With reference now to FIG. 1, a flow diagram of a method 100 for iteratively performing SS-RTM is provided in accordance with at least one embodiment of the present invention. The method 100 may be advantageously implemented in connection with any appropriate method and/or system, such as a computer implemented system, to meet the design criteria of a particular application. The method 100 generally includes a plurality of blocks or steps that may be performed serially. As will be appreciated by one of ordinary skill in the art, the order of the steps shown in FIG. 1 is exemplary and the order of one or more steps may be modified within the spirit and scope of the present invention. Additionally, the steps of the method 100 may be performed in at least one non-serial (or non-sequential) order, and one or more steps may be omitted to meet the design criteria of a particular application. Block 102 represents an entry point into the method 100.

At block 104, a Setₙ of Random Encoding Functions is selected. The Setₙ comprises Random Encoding Functions Aₙ and Bₙ, where Bₙ is generally reciprocal to Aₙ. It may be noted, however, that in at least one embodiment Aₙ may be identical to or equivalent to Bₙ.

At block 106, the Forward (i.e., source) Wave Components of a set of shot gathers are encoded using the Random Encoding Function Aₙ to generate an Encoded Source Super-Shot Wave Component.

At block 108, the Backward (i.e., received) Wave Components of the set of shot gathers are encoded using Random Encoding Function Bₙ to generate an Encoded Receiver Super-Shot Wave Component.

At block 110, the Encoded Source Super-Shot Wave Component is forward propagated to generate a Forward Propagated Wave Component.

At block 112, the Encoded Receiver Super-Shot Wave Component is back propagated to generate a Back Propagated Wave Component.

At block 114, an imaging condition is applied to the Forward Propagated Wave Component and the Back Propagated Wave Component to generate a Subsurface Image (SIₙ).

The steps represented by blocks 104-114 may be performed for any appropriate number of iterations to satisfy the design criteria of a particular application. Decision block 116 represents the determination of whether or not additional iterations are desirable. If additional iterations are desirable, then the method 100 generally returns to block/step 104. Each Setₙ selected at block 104 is unique in that each set includes at least one member that makes the set, as a whole, different from any previously selected set. For example, a Set₁ may include Reciprocal Random Encoding Functions X and Y and Set₂ may include Reciprocal Random Encoding Functions X and Z. Set₁ and Set₂ are unique because the set XY is not identical to the set XZ. It may be appreciated that subscript n represents an indexing digit that is generally modified upon each iteration.

If the method 100 does not return to block 104 then the method 100 generally falls through to block 118. Block 118 represents an exit from the method 100.

As illustrated in FIG. 1, then, SS-RTM is generally performed repeatedly (i.e., more than once) on a given seismic data set (e.g., shot gather set) using reciprocal sets of source and receiver random encoding functions aₙ(i)'s and bₙ(i)'s respectively. For such reciprocal encodings, the n-th SS-RTM image would be described by:

$$\begin{matrix}{Image}_{n} = F [ {\sum }_{i} {a}_{n} ( i ) S ( i ) ] ⊗ B [ \sum {b}_{n} ( k ) R ( k , j ) ] \\ = ( {\sum }_{i} {a}_{n} ( i ) {b}_{n} * ( i ) F [ S ( i ) ] ⊗ B [ R ( i , j ) ] ) + \\ ( {\sum }_{i , k} {a}_{n} ( i ) {b}_{n} * ( k ) F [ S ( i ) ] ⊗ B [ R ( k , j ) ] ) \\ = ( {\sum }_{i} F [ S ( i ) ] ⊗ B [ R ( i , j ) ] ) + \\ ( {\sum }_{i , k} {a}_{n} ( i ) {b}_{n} * ( k ) F [ S ( i ) ] ⊗ B [ R ( k , j ) ] ) , \\ = Signal + {Noise}_{n}\end{matrix} \qquad [ EQ10 ]$$

The use of reciprocal encodings insures that each SS-RTM image is comprised of both the desired signal (with unit magnitudes in each Image) and a noise that varies across the different SS-RTM images.

In at least one embodiment, unit-magnitude complex numbers may be used as aₙ(i)'s. In such an embodiment aₙ(i)=bₙ(i), |aₙ(i)|=|bₙ(i)|=1, and the n-th SS-RTM image would be described by:

$$\begin{matrix}{Image}_{n} = F [ {\sum }_{i} {a}_{n} ( i ) S ( i ) ] ⊗ B [ \sum {a}_{n} ( k ) R ( k , j ) ] \\ = ( {\sum }_{i} {\vert {a}_{n} ( i ) \vert}^{2} F [ S ( i ) ] ⊗ B [ R ( i , j ) ] ) + \\ ( {\sum }_{i , k} {a}_{n} ( i ) {a}_{n} * ( k ) F [ S ( i ) ⊗ B [ R ( k , j ) ] ) , \\ = ( {\sum }_{i} F [ S ( i ) ] ⊗ B [ R ( i , j ) ] ) + \\ ( {\sum }_{i , k} exp ( j {θ}_{n} ( i , k ) ) F [ S ( i ) ] ⊗ B [ R ( k , j ) ] ) , \\ = Signal + {Noise}_{n}\end{matrix} \qquad [ EQ11 ]$$

where θₙ(i,k) is the phase difference between aₙ(i) and aₙ*(k). Once again, the use of unit-magnitude encodings generally provides a signal component that does not vary and a noise component that varies in phase across different SS-RTM images. As the number of RTM runs (i.e., iterations) increases, the probability that an interference induced noise event does not change phase drops exponentially.

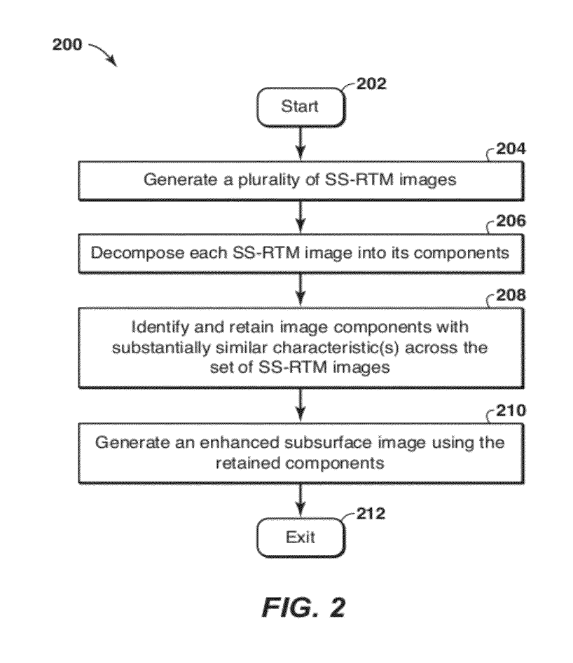

With reference now to FIG. 2, a flow diagram of a method 200 for generating an enhanced image is provided in accordance with at least one embodiment of the present invention. The method 200 may be advantageously implemented in connection with any appropriate method, such as the method 100, and/or system, such as a computer implemented system, to meet the design criteria of a particular application. The method 200 generally includes a plurality of blocks or steps that may be performed serially. As will be appreciated by one of ordinary skill in the art, the order of the steps shown in FIG. 2 is exemplary and the order of one or more steps may be modified within the spirit and scope of the present invention. Additionally, the steps of the method 200 may be performed in at least one non-serial (or non-sequential) order, and one or more steps may be omitted to meet the design criteria of a particular application. Block 202 represents an entry point into the method 200.

At block 204 a plurality of SS-RTM images are generated using different (i.e., unique) random reciprocal sets of encoding functions. In at least one embodiment the SS-RTM images are generated using the method 100 of FIG. 1, above. However, any appropriate method and/or system may be used to generate the images to satisfy the design criteria of a particular application.

At block 206 each SS-RTM image is decomposed into its components. In at least one embodiment, the decomposition is performed by transforming the image into a different domain (e.g., frequency). In one embodiment a linear transform such as the Fourier transform, wavelet transform, curvelet transform, F-K transform, radon transform, and/or the like may be used to decompose the image into transform domain coefficients (fourier/wavelet/curvelet, F-K, radon coefficients). However, any appropriate technique may be used to satisfy the design criteria of a particular application.

At block 208, image components with substantially similar characteristic(s), such as phase and/or magnitude coefficients, across the set of SS-RTM images are identified. Substantially constant components are generally associated with signal energy and, therefore, are retained. Alternatively, if the characteristic(s) of an image component varies across the set of SS-RTM images, then such a component predominantly contains noise energy and, therefore, may preferably be attenuated.

At block 210 an enhanced subsurface image may be generated by combining the retained components. In general, the enhanced image will exhibit less noise than an image resulting directly from SS-RTM.

Block 212 represents an exit from the method 200.

In summary, each original SS-RTM image may include constant signal terms as well as variable noise terms. If, for example, a reflection event in an SS-RTM image maintains a substantially constant amplitude across SS-RTM images (i.e., runs), then that reflection event is likely to be a part of the desired signal. In contrast, if a reflection event varies across SS-RTM runs, then that reflection event is a component of interference noise and should be attenuated.

In at least one specific embodiment, the method 200 of FIG. 2 may include the following steps:
1. A plurality of SS-RTM images are generated using different known random reciprocal unit-magnitude encoding functions (e.g., step 204).
2. The curvelet transform of all the SS-RTM images are generated (e.g., step 206).
3. The set of curvelet coefficients from all the SS-RTM coefficients that contain a specific dip, frequency, and location are identified and combined to form an enhanced curvelet coefficient (e.g., step 208). More specifically:
   i. The set of curvelet coefficients are averaged to provide a preliminary signal curvelet coefficient estimate.
   ii. The noise level in the preliminary signal coefficient estimate is deduced by computing the variance of the set of curvelet coefficients
   iii. If the signal curvelet coefficient estimate's energy is substantially larger than the noise level, then the coefficient is retained almost unaltered (primarily signal). If the noise level is large, then the coefficient is attenuated (primarily noise). It may be noted that one skilled in the art having the benefit of this disclosure may select among any one or more of several techniques to perform the signal to noise comparison (e.g., hard-thresholding, soft-thresholding, empirical Bayes thresholding, Wiener filtering, or the like).
4. The inverse curvelet transform of the retained coefficients may then be generated to obtain the interference-free RTM image (e.g., step 210).

While the present invention has generally been described with encoding performed using scalars in the time domain, it should be understood that the invention may also be extended to include frequency-domain encodings. Different sets of reciprocal source and receiver random encoding functions, aₙ(i)[f]'s and bₙ(i)[f]'s respectively, may be used for each frequency f of the source function and receiver measurement, such that aₙ(i)[f]=1/bₙ*(i)[f] or aₙ(i)[f]=bₙ(i)[f]=0. Crosscorrelation in the time domain is equivalent to multiplication with complex conjugation in the frequency domain. Therefore, by using different reciprocal encodings in the frequency domain, the SS-RTM image resulting from frequency component f is given by:

$${Image}_{n} [ f ] = F [ {\sum }_{i} {a}_{n} ( i ) [ f ] S ( i ) [ f ] ] B [ \sum {b}_{n} * ( k ) [ f ] R * ( k , j ) [ f ] ] = ( {\sum }_{i} {a}_{n} ( i ) [ f ] {b}_{n} * ( i ) [ f ] F [ S ( i ) [ f ] ] B [ R ( i , j ) * [ f ] ] ) + ( {\sum }_{i , k} {a}_{n} ( i ) [ f ] {b}_{n} * ( k ) [ f ] F [ S ( i ) [ f ] ] B [ R * ( k , j ) [ f ] ] ) . = ( {\sum }_{i} F [ S ( i ) [ f ] ] B [ R ( i , j ) * [ f ] ] ) + ( {\sum }_{i , k} {a}_{n} ( i ) [ f ] {b}_{n} * ( k ) [ f ] F [ S ( i ) [ f ] ] B [ R * ( k , j ) [ f ] ] ) . = Signal [ f ] + {Noise}_{n} [ f ] \qquad [ EQ12 ]$$

The total image may be generated by summing over all frequency contributions. Again, as described earlier, unlike the signal component, the noise does generally vary across SS-RTM runs.

A known special case of SS-RTM employs so-called plane waves. In such a case, the source functions and receiver measurements are delayed so that the effective source functions and receiver measurements resemble planar waves. Plane-wave decomposed source functions and receiver measurements may then be used as effective sources and receivers and a plane-wave SS-RTM image may be constructed using, for example, equation [EQ12]. Note that time-domain delays is equivalent to linear phase encodings in the frequency domain.

In at least one embodiment, then, step 204 of method 200 may be implemented using different reciprocal random encoding functions on plane waves with different angle of incidence. Such an approach is mathematically equivalent to constructing the frequency domain encodings (i.e., aₙ(i)[f]) by randomly combining linear phase encodings. In such a case, bₙ(i)[f]=1/aₙ(i)[f].

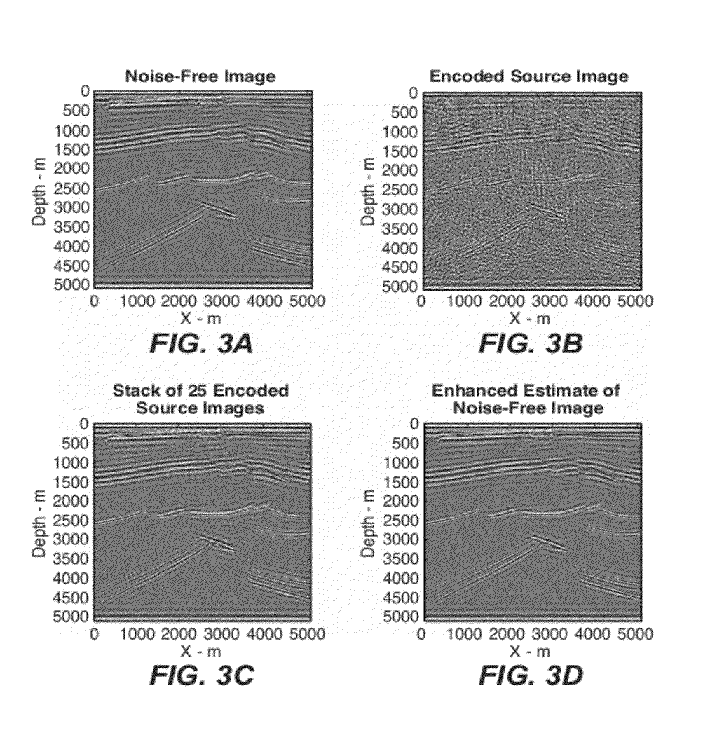

With reference now to FIGS. 3A-3D, images from a specific example are shown to further illustrate the application of one or more embodiments of the present invention. It should be understood that these images and the corresponding discussion that follows are provided for clarity and are not intended to limit the present invention in any manner beyond the limits setout in the attached claims. The individual shots were simulated with marine streamer geometry.

FIG. 3A shows a simulated stacked RTM image obtained by migrating 383 individual shots along the 2D line. As such, this image represents the results of conventional SS-RTM migration and may be used as a benchmark to exemplify the quality of the present invention. It may be noted that these individual shots were encoded using time-domain binary (±1) encoding scheme.

FIG. 3B shows an image obtained by simulating RTM on one encoded simultaneous source super-gather. One may note that the image is noisy with poor signal-to-noise ratio (SNR). FIG. 3C shows a corresponding stack of 25 such SS-RTM images, each obtained with a different encoding (generally corresponding to step 204 of method 200). The image is an improvement over the FIG. 3B. However, even after 25 stacks visible noise in still observable. Next we apply steps 206 and 208 of method 200 using curvelet transform and wiener filtering. The resulting enhanced image (e.g., result of step 210 of the method 200) is shown in FIG. 3D. The quality of the image is very similar to the image in FIG. 3A; which is the desired result.

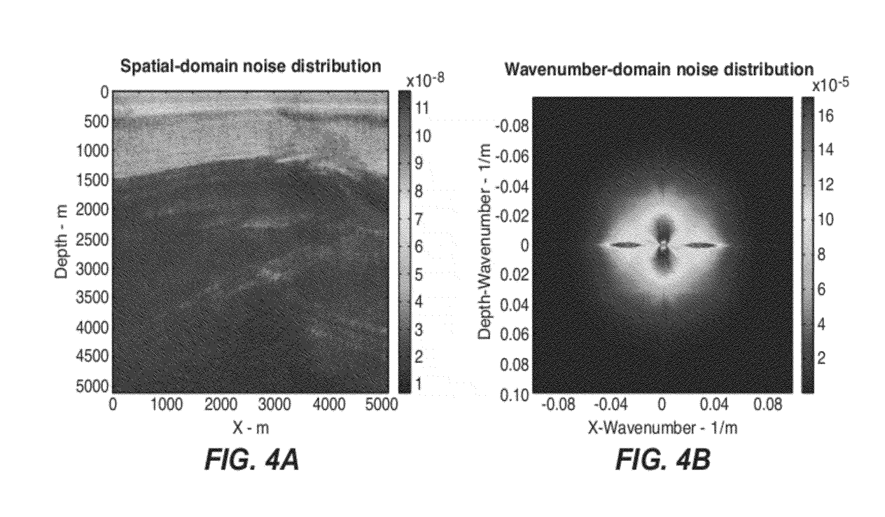

With reference now to FIG. 4A, a distribution of the noise spatially for the curvelet coefficients of the example of FIGS. 3A-3D is shown. From the figure, one may observe that the noise is greater in the shallow part than the deeper part. Recognizing such spatial distribution is beneficial in deciding the threshold used to carry out de-noising. FIG. 4B shows the noise distribution in spatial wavenumber domain. Examining the distribution in different domains may be beneficial is designing appropriate filters that protect the signal.

As previously mentioned, the present invention has been described in the context of SS-RTM. It should be understood, however, that the invention has broader applicability and may be used in connection with many other computation intensive operations, including iterative inversion techniques. For example, the present invention may also be applied to efficiently compute gradients during Full Waveform Inversion (i.e., FWI). In general, FWI estimates a model of subsurface parameters (such as wave propagation velocities) by iteratively minimizing the difference between observed data and data simulated with the subsurface parameter model. One step in FWI is computing the gradient of a cost function. This gradient computation step is nearly identical to RTM in terms of being computationally expensive. In at least one embodiment the present invention may be applied to speed up gradient computation as follows:
1. Generate the gradients of objective functions computed using different sets of known random reciprocal encoding functions (similar to step 204 of method 200).
2. Decompose each gradient image into its components by, for example, transforming each gradient into a different domain (similar to step 206 of method 200).
3. If the characteristics (such as phase and magnitude) of an image component are similar across all gradients, then the component contains predominantly signal energy and, therefore, is retained. In contrast, if the characteristics (such as phase and magnitude) of an image component vary across all or most gradients, then the component contains predominantly noise energy and, therefore, is attenuated (similar to step 208 of method 200).
4. Construct an enhanced gradient by combining all of the retained components (similar to step 210 of method 200).

Accordingly, one of ordinary skill in the art may appreciate, given the benefit of this disclosure, that the method 200 may be implemented with any of a number of computationally intensive processes substituted for SS-RTM.

In accordance with various embodiments of the present invention, the methods described herein are intended for operation as software programs running on a computer processor. Dedicated hardware implementations including, but not limited to, application specific integrated circuits, programmable logic arrays, microprocessor based devices, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

### REFERENCES

Baysal, E., Kosloff, D. D. and Sherwood, J. W. C., “Reverse time migration,” Geophysics 48(11), 1514-1524 (1993).
Dai, W. and Schuster, J., “Least-squares migration of simultaneous sources data with a deblurring filter,” SEG Expanded Abstract, 2990-2994 (2009).
Godwin, J. and Sava, P., “Simultaneous source imaging by amplitude encoding,” CWP Report 645, 21-41 (2010).
C. C. Ober, L. A. Romero and D. C. Ghiglia, “Method of migrating seismic records,” U.S. Pat. No. 6,021,094 (2000)
L. A. Romero, D. C. Ghiglia, C. C. Ober and S. A. Morton, “Phase encoding of shot records in prestack migration,” Geophysics 65(2), 426-436 (2000).
F. Perrone and P. Sava, “Comparison of shot encoding functions for reverse-time migration,” SEG Expanded Abstract, 2980-2984 (2009).
F. Perrone and P. Sava, “Wave-equation migration with dithered plane waves,” CWP Report 646, 43-64 (2010).
Claerbout, J. F., “Imaging the earth's interior,” Blackwell Scientific Publications (1985).
Stolt, R. H., “Migration by Fourier transform,” Geophysics 43, 23-48 (1978).
Tang, Y. and Biondi, B., “Least-squares migration/inversion o blended data,” SEG Expanded Abstract, 1041-1044 (2009).
Verschuur, D. J. and Berkhout, A. J., “Target oriented least-squares imaging of blended data,” SEG Expanded Abstract, 2889-2893 (2009).
Whitmore, N. D., “Iterative depth migration by backward time propagation,” SEG Expanded Abstract, 382-385 (1983).
Yilmaz, “Seismic Data Processing,” Society of Exploration Geophysicists (1987).

What is claimed is:

1. A method for processing seismic data, the method comprising:
a. obtaining a plurality of initial subsurface images, wherein each of the initial subsurface images is generated using a unique random set of encoding functions;
b. decomposing each of the initial subsurface images into components;
c. identifying a set of components comprising one of (i) components having at least one substantially similar characteristic across the plurality of initial subsurface images, and (ii) components having substantially dissimilar characteristics across the plurality of initial subsurface images; and
d. generating an enhanced subsurface image using the set of components identified in step c.

2. The method of claim 1 wherein the initial subsurface images and the enhanced subsurface image are SS-RTM images.

3. The method of claim 1 further comprising the step of attenuating components not identified as having at least one substantially similar characteristic across the plurality of initial subsurface images.

4. The method of claim 1 wherein decomposing each initial subsurface image includes transforming each initial subsurface image into another domain.

5. The method of claim 4 wherein the domain is frequency.

6. The method of claim 4 wherein a curvelet transform is used to transform each initial subsurface image into another domain.

7. The method of claim 4 wherein at least one of a fourier transform, wavelet transform, F-K transform, curvelet transform, and radon transform is used to transform a subsurface image into another domain.

8. The method of claim 1 wherein the initial subsurface images are generated by:
a. obtaining a set of shot gathers comprising forward and backward wave component data;
b. selecting first and second random encoding functions;
c. encoding the forward wave component data for each source in the set of shot gathers using the first random encoding function to form an Encoded Source Super-Shot Wave Component;
d. encoding the backward wave component data for each receiver in the set of shot gathers using the second random encoding function to form an Encoded Receiver Super-Shot Wave Component;
e. forward propagating the Encoded Source Super-Shot Wave Component to generate a Forward Propagated Wave Component;
f. back propagating the Encoded Receiver Super-Shot Wave Component to generate a Back Propagated Wave Component;
g. applying an imaging condition to the Forward and Back Propagated Wave Components to generate a subsurface image; and
h. iteratively repeating steps b-g until a predetermined condition is satisfied, wherein the first and second random encoding functions are selected so that the functions are unique for each iteration.

9. The method of claim 8 wherein the encoding the forward and backward wave components is performed using scalars in the time domain.

10. The method of claim 8 wherein the encoding the forward and backward wave components is performed using scalars in the frequency domain.

11. The method of claim 8 wherein the first and second random encoding functions are reciprocal.

12. The method of claim 11 wherein at least one of the first and second reciprocal random encoding functions is a unit-magnitude encoding function.

13. The method of claim 12 wherein one or more of the first and second reciprocal random encoding function include a unit-magnitude complex number encoding function.

14. The method of claim 8 wherein the first and second random encoding functions include reciprocal random encoding functions on plane waves with different angles of incidence.

15. The method of claim 8 wherein the first random encoding function is equivalent to the second random encoding function.

16. A method for processing seismic data, the method comprising:
a. obtaining a plurality of SS-RTM subsurface images, wherein each of the SS-RTM subsurface images is generated using a unique random unit-magnitude set of encoding functions;
b. decomposing each of the plurality of SS-RTM subsurface images into curvelet coefficients;
c. averaging the curvelet coefficients to generate a preliminary signal curvelet coefficient estimate;
d. computing a variance of a subset of the curvelet coefficients to determine a noise level in the preliminary signal curvelet coefficient estimate;
e. attenuating noise in the curvelet coefficients using the determined noise level and the preliminary signal curvelet coefficient estimate to generate attenuated curvelet coefficients; and
f. performing an inverse curvelet transform on the attenuated curvelet coefficients to generate an enhanced SS-RTM image.

17. The method of claim 16 wherein step e is performed using one or more of hard-thresholding, soft-thresholding, empirical Bayes thresholding, and Wiener filtering.

18. A method for computing a gradient of a cost function associated with seismic data, the method comprising:
a. generating a plurality of gradients of objective functions computed using unique sets of random reciprocal encoding functions;
b. decomposing each of the gradients into components;
c. identifying a set of components having at least one substantially similar characteristic across the plurality of gradients; and
d. generating an enhanced gradient using the set of components identified in step c.
